(19) United States
(12) Patent Application Publication
(10) Pub. No.: US 2006/0064572 A1
(43) Pub. Date: Mar. 23, 2006

(54) Automatic initialization

(75) Inventor: John Packer, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: ADAPTEC, INC., MILPITAS, CA (US)

(21) Appl. No.: 11/222,909

(22) Filed: Sep. 8, 2005

Related U.S. Application Data
(63) Continuation-in-part of application No. 11/075,542, filed on Mar. 8, 2005, now abandoned.
(60) Provisional application No. 60/551,675, filed on Mar. 8, 2004.

(51) Int. Cl. G06F 15/177

(52) U.S. Cl. 713/1

(57) ABSTRACT

A system and method of initializing an integrated circuit. The method includes initiating the integrated circuit and loading at least one initialization word from storage device. The storage device can be external from the integrated circuit. The integrated circuit can be initialized with at least one data value in the at least one initialization word. A system for initializing an integrated circuit is also disclosed.

### CROSS REFERENCE TO RELATED APPLICATIONS

This application is a continuation-in-part of and claims priority from U.S. patent application Ser. No. 11/075,542 filed on Mar. 8, 2005 and “Hardware Interlock for SAS Link Usage of Common Context Memory,” which is incorporated herein by reference in its entirety and which claims priority from U.S. Provisional Patent Application No. 60/551,675 filed on Mar. 8, 2004 and entitled “Hardware Interlock,” which is incorporated herein by reference in its entirety.

### BACKGROUND

The present invention relates generally to system initialization, and more particularly, to methods and systems for improved, faster system initialization.

Many integrated circuits (e.g., microprocessors and ASICs (application specific integrated circuits)) include jumpers that allow selection of some of the initialization conditions and settings. The jumpers may also allow a user to select from a set of operating conditions. By way of example, the jumpers can allow setting selected bits to a “1” or a “0” value. During initialization, the IC uses the value of the selected bits to indicate to the IC how to perform certain functions. In another example, the value of the selected bits may indicate which one of two (or more) sets of values the IC should apply to certain registers. Specifically, if a selected bit is jumped to a “1” then the IC loads a first set of values in a first register. Similarly, if the selected bit is jumped to a “0” then the IC loads a second set of values in the first register.

These external jumpers allow the IC some limited configuration. This limited configuration can allow the IC to be used in more than one application. By way of example, setting a first jumper to a “1” value may configure the IC's input/output (I/O) settings to be compatible with a first external circuit or device. By way of example, if the IC is a video processor for a personal computer, setting a first jumper to a “1” value may configure the video processor's I/O to interface with an Intel microprocessor (e.g., x86, Pentium, etc.) where setting the first jumper to a “0” value may configure the video processor's I/O to interface with an AMD microprocessor (e.g., Athalon, etc.).

While the external jumpers allow the IC to be configurable, the number of configurations is limited by the number of pins that can have jumpers applied to them. By way of example, if a given IC has 64 total pins and only 20 of those pins are available for configuration purposes with respective jumpers, then the number of configurations of the IC is limited to the number of combinations of the 20 pins available for configuration purposes. As a direct result, manufacturers of IC's are required to make multiple families of ICs where each IC in the family performs the same core functions but is configurable 20-40 different ways. In this way the manufacturer can market the core functions of the IC that can be applied to as many of the available market applications, as possible.

Unfortunately, while each of these ICs in the IC families include the same core functionality, they cannot be used in every possible application and therefore, added design and production costs are required to produce these families of ICs. In view of the foregoing, there is a need for a simpler, more flexible system and method for setting initialization and configuration conditions so as to allow an ICs with a core functionality to be used with more of the available market applications while reducing the design and production costs.

### SUMMARY

Broadly speaking, the present invention fills these needs by providing a simpler, more flexible system and method for setting IC initialization and configuration conditions. It should be appreciated that the present invention can be implemented in numerous ways, including as a process, an apparatus, a system, computer readable media, or a device. Several inventive embodiments of the present invention are described below.

One embodiment provides a method of initializing an integrated circuit. The method includes initiating the integrated circuit and loading at least one initialization word from storage device. The storage device can be external from the integrated circuit. The integrated circuit can be initialized with at least one data value in the at least one initialization word.

The method can also include calculating a checksum value from the loaded at least one initialization word, determining if the calculated checksum matches an appended checksum. The appended checksum being appended to the at least one initialization word and initializing the integrated circuit with at least one data value in the at least one initialization word if the calculated checksum matches the appended checksum. The method can also include setting a checksum error flag if the calculated checksum does not match the appended checksum.

The external storage device can be an electronically readable and writeable medium. The external storage device can be an EPROM. Initiating the integrated circuit can include at least one of a reset event, a restart event or a power-on event.

The initialization word is electronically readable. The initialization word can be electronically writeable. Loading at least one initialization word from storage device includes determining if the storage device is present. The method can also include determining if a secondary external storage device is present if the external storage device is not present.

The integrated circuit can include a processor and the at least one initialization word can include software executable on the processor.

Another embodiment provides a system including an integrated circuit including at least one initialization register, a first storage device coupled to the at least one initialization register in the integrated circuit via a first bus and at least one initialization word stored in the first storage device. The initialization word being electronically readable and the at least one initialization word being capable of being read into the at least one initialization register upon an initialization event.

The at least one initialization word can be electronically writeable. The system can also include a system processor coupled to the first storage device. The system processor is capable of writing the at least one initialization word into the first storage device.

The at least one initialization word can include a checksum. The at least one initialization word can include a sequential access parameter. The at least one initialization word can include a random access parameter.

The initialization event can include at least one of a reset event, a restart event or a power-on event. The system can also include a second storage device coupled to the at least one initialization register in the integrated circuit via the first bus.

Yet another embodiment provides an interface device. The interface device including an interface circuit including at least one initialization register and an input/output processor, a first storage device coupled to the at least one initialization register in the integrated circuit via a first bus, at least one initialization word stored in the first storage device, the initialization word being electronically readable, the at least one initialization word being capable of being read into the at least one initialization register upon an initialization event. A system processor is coupled to the first storage device. The system processor being capable of writing the at least one initialization word into the first storage device. The system processor being coupled to the input/output processor by a system bus and a peripheral device coupled to the input/output processor by a peripheral device-specific bus.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings.

FIG. 1 is a block diagram of an IC and an external initialization word storage device, in accordance with one embodiment of the present invention.

FIG. 2 is a flowchart that illustrates the method operations performed upon start-up of the IC, in accordance with one embodiment of the present invention.

FIGS. 3-5 are tables of instruction loading registers, in accordance with one embodiment of the present invention.

### DETAILED DESCRIPTION

Several exemplary embodiments for a simpler, more flexible system and method for setting IC initialization and configuration conditions will now be described. It will be apparent to those skilled in the art that the present invention may be practiced without some or all of the specific details set forth herein.

When an IC is first powered up it is desirable to be able to configure the IC with different options. This is especially desirable if the IC is a more complicated IC such as an ASIC. It is also desirable to make the configuration as programmable as possible. By way of example, an internal register can be loaded with one or more desired configuration data values.

The IC can automatically read in the configuration data values in the form of “automatic initialization words” from an external device or source (e.g., an external register, a memory location, EPROM, etc.). The automatic initialization words can direct logic in the IC to generate internal register accesses. As the automatic initialization words are read the actions defined by the automatic initialization words are performed in the IC. It should be noted that no processor is required to load the initialization words in the IC. The initialization words are read into the IC as part of the initialization of the IC. Since the initialization words are stored externally from the IC, the initialization words can be modified (e.g., updated, replaced, etc.) as needed over time.

It should be noted that while the following detailed description describes how the present invention can be implemented for an EEPROM device as an external initialization word storage device, it should be understood that the invention could be used for any external device having any data width (e.g., an 8-bit, 16-bit, 32-bit, 64-bit, etc.).

As described above, most IC's provide a hardwired (i.e., jumper) method to configure a limited number of internal control settings. The configuration jumper state/position can be used to directly select a control setting. Alternatively, the jumper state/position can be sampled with an initialization signal (e.g. a reset) and store the signal in a register. Unfortunately this severely restricts the flexibility of the IC's configuration.

Another problem with the configuration jumper is that all configuration register configuration must be determined need before the IC is built. One advantage of the present invention is that the correct external initialization code word can be loaded into the IC to configure any register in the IC.

Many have attempted to increase the flexibility of the IC by having a processor, either internal or more often external to the IC load configuration values into the IC. However, this requires a processor to perform this function. Providing that capability for the IC to automatically load externally stored initialization words that in turn configure the IC is more desirable.

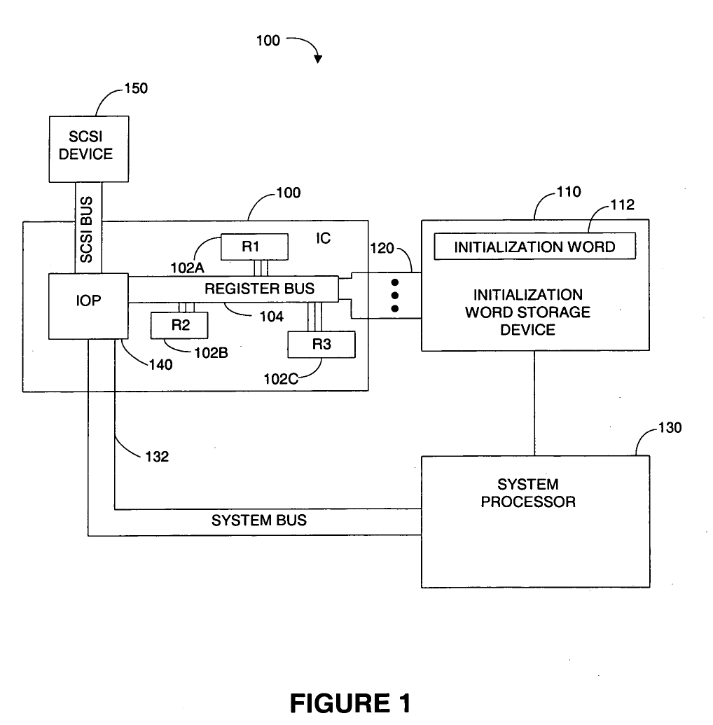

FIG. 1 is a block diagram of an IC 100 and an external initialization word storage device 110, in accordance with one embodiment of the present invention. The external initialization word storage device 110 includes one or more initialization words 112. The IC 100 includes multiple initialization registers 102A-102C for receiving the initialization values included in the one or more initialization words 112. The IC 100 is coupled to the external initialization word storage device 110 via one or more data lines 120. The one or more data lines 120 can comprise a data bus. The data lines 120 can connect to an internal register bus 104. The internal register bus 104 is connected to each of the multiple initialization registers 102A-102C.

An optional processor 130 can also be coupled to the external initialization word storage device 110. The processor 130 can update or modify the initialization word(s) 112 stored in the external initialization word storage device 110.

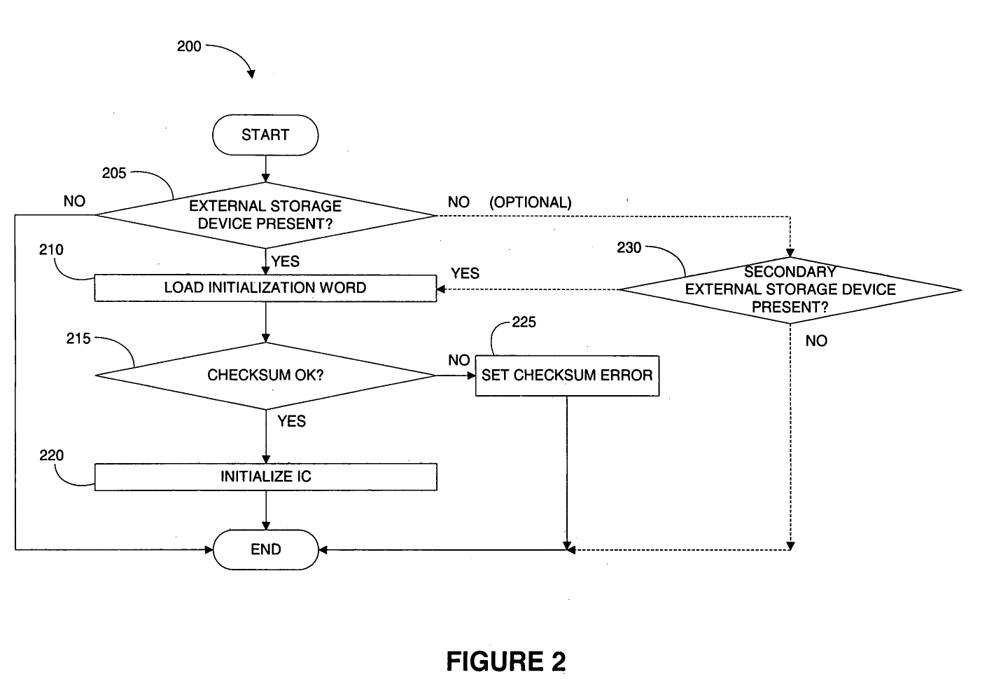

FIG. 2 is a flowchart that illustrates the method operations 200 performed upon start-up of the IC 100, in accordance with one embodiment of the present invention. Upon a reset or restart or power-on, the IC 100 can check if an external initialization word storage device 110 is present in an operation 205. The presence of the external initialization word storage device 110 can be indicated by a jumper or other indicator connected to the IC 100.

By way of example, the external initialization word storage device 110 can tie one of the one or more data lines 120 to a high potential (e.g., logical 1 value) or a low potential (e.g., logical 0 value) inside the external initialization word storage device. Therefore, the presence of the external initialization word storage device 110 can be immediately detected by the IC 100.

If the external initialization word storage device 110 is detected in operation 205, then the method operations continue in an operation 210. In operation 210, the initialization word 112 is retrieved from the external initialization word storage device 110 and the method operations continue in operation 215.

In operation 215, a checksum operation is performed on the initialization word 112 to determine if the initialization word is a valid value or not. The checksum operation can be any type of checksum operation suitable for this application.

If in operation 215, the checksum operation is not successful, then the method operations continue in an operation 225. In operation 225, a check sum error indicator is set and the method operations can end. By way of example, a predetermined register location can be set to a value indicating a check sum error.

If in operation 215, the checksum operation is successful, then the initialization word is used by the IC to initialize the IC in an operation 220. By way of example, the initialization word is loaded into the initialization registers 102A-102B. While the description herein is described in terms of a single initialization word, it should be understood that the initialization word could include multiple initialization words. Further, one or more initialization words can be loaded into each one or more than one of the initialization registers 102A-102B.

Referring again to operation 205, if the external initialization word storage device 110 is not detected in operation 205, then the method operations can end. Alternatively, if the external initialization word storage device 110 is not detected in operation 205, then the method operations can continue in an optional operation 230. In optional operation 230, the IC 100 can check if a second external initialization word storage device (not shown) is present. The presence of the second external initialization word storage device can be indicated by a jumper or other indicator connected to the IC 100. If the second external initialization word storage device is not detected in operation 230, then the method operations can end.

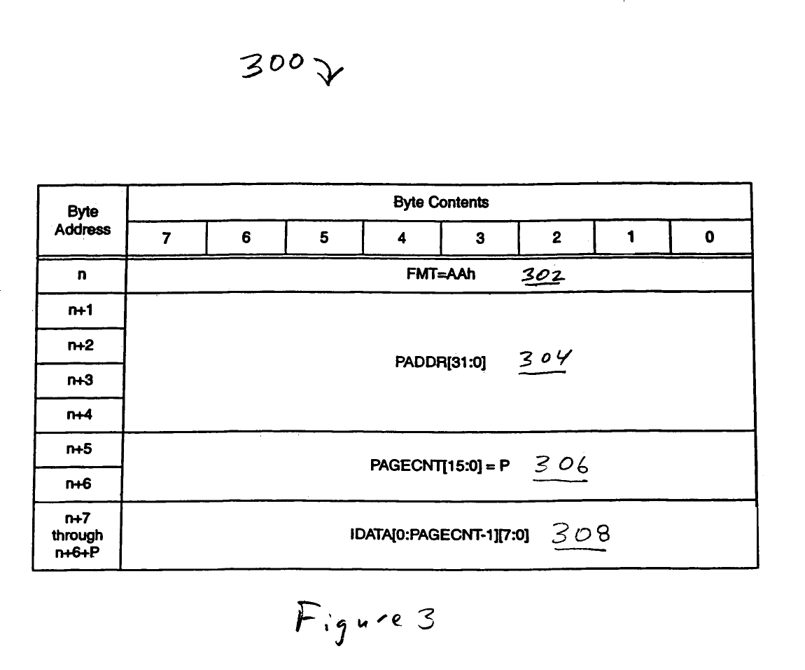

FIGS. 3-5 are tables of instruction loading registers 300, 400 and 500, respectively, in accordance with one embodiment of the present invention. The instruction loading registers 300, 400 and 500 are examples of the initialization word 112. The IC 100 can pull in the data in the instructions loading registers as described above. The instruction loading registers 300, 400 and 500 can hold different types of instructions. IC 100 will fetch initialization information from the external initialization word storage device 110 (e.g., EPROM or similar storage device). The external initialization word storage device 110 includes initialization “pages.” The first byte of each initialization page can be used to determine the format of the data included in the initialization page. The following are exemplary initialization page formats:

| First Byte Value | Data Format |
|---|---|
| AAh (or any value not 00h or FFh) | Sequential Access Parameters |
| ABh (or any value not 00h or FFh) | Random Access Parameters |
| 55h (or any value not 00h or FFh) | Last Page with Checksum |

FIG. 3 shows an instruction loading registers 300 having an initialization page format AAh 302. The initialization page format 300 can be used for loading sequential parameters starting from a defined address 304 (e.g., PADDR). Bytes 5 and 6 of this page are the PAGECNT field 306. The PAGECNT field 306 defines the number of initialization data bytes 308 that follow. The PAGECNT field 306 can be used to determine the end of the page. The IC 100 can start a control fabric address at PADDR[31:0] for the first byte of IDATA 308, and increment the address for each subsequent byte.

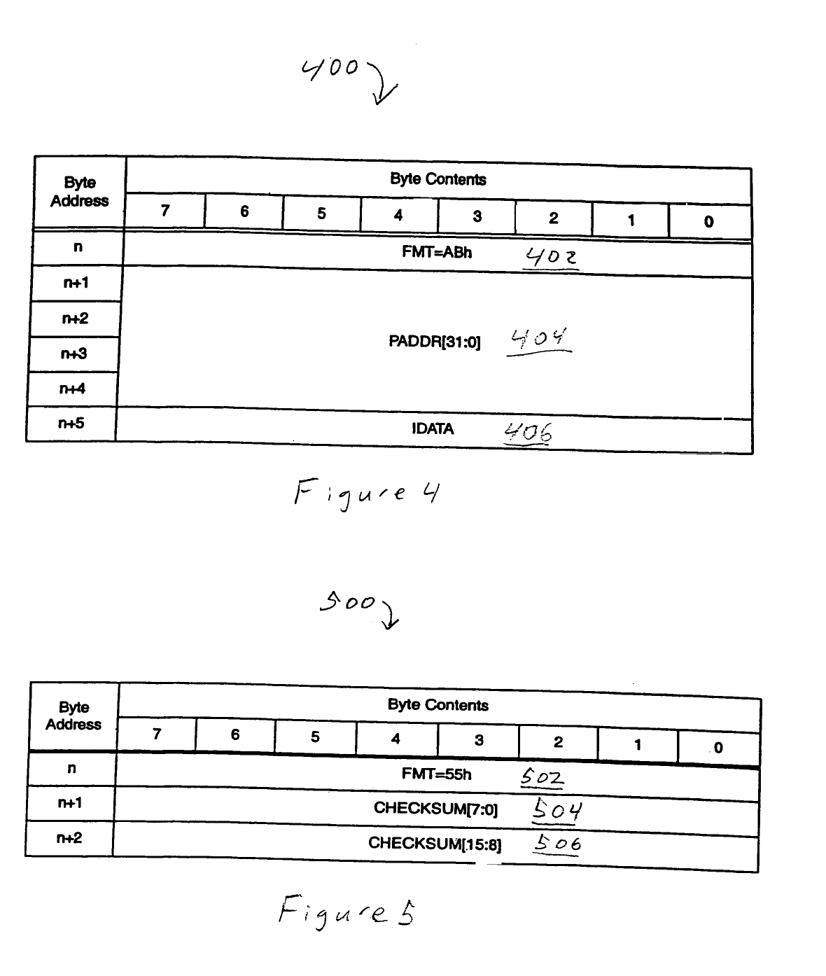

FIG. 4 shows an instruction loading registers 400 having an initialization page format ABh 402. The page format ABh 402 can be used-for loading random parameters 404. The IDATA 406 is always one byte that is written at the address PADDR[31:0].

FIG. 5 shows an instruction loading registers 500 having an initialization page format 55h 502. The page format 55h 502 can be used to indicate the last page and supply the checksum 506.

The instruction loading registers 300, 400 and 500 can also be used to load software in the IC 100. By way of example, the IC 100 can include a processor 140. The processor 140 initialization registers 102A-C can be loaded with the software and or initialization parameters utilized by the processor 140 to perform the desired functions.

In a more specific example, the IC 100 can be a peripheral device specific input/output interface and the processor 140 can be an input/output processor (IOP). The IC 100 can be an interface between the system processor 130 and a specific type of peripheral device. By way of example, the peripheral device can be a SCSI device or similar peripheral device. The system bus 132 can couple the system processor 130 to the IC 100 and the SCSI bus 152 can couple the IC 100 to a SCSI device 150. Upon start up or restart or power on, the initialization registers 102A-C can be loaded with the software stored in the initialization words 112. In this manner, the IC 100 as a SCSI input/output interface device can be easily configured to work with many different system processors 130 and many different SCSI devices 150.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

It will be further appreciated that the instructions represented by the operations in the above figures are not required to be performed in the order illustrated, and that all the processing represented by the operations may not be necessary to practice the invention. Further, the processes described in any of the above figures can also be implemented in software stored in any one of or combinations of the RAM, the ROM, or the hard disk drive.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method of initializing an integrated circuit comprising:
initiating the integrated circuit;
loading at least one initialization word from storage device, wherein the storage device is external from the integrated circuit; and
initializing the integrated circuit with at least one data value in the at least one initialization word.

2. The method of claim 1, further comprising:
calculating a checksum value from the loaded at least one initialization word;
determining if the calculated checksum matches an appended checksum, the appended checksum being appended to the at least one initialization word; and
initializing the integrated circuit with at least one data value in the at least one initialization word if the calculated checksum matches the appended checksum.

3. The method of claim 2, further comprising setting a checksum error flag if the calculated checksum does not match the appended checksum.

4. The method of claim 1, wherein the external storage device is an electronically readable and writable medium.

5. The method of claim 1, wherein the external storage device is an EPROM.

6. The method of claim 1, wherein initiating the integrated circuit includes at least one of a reset event, a restart event or a power-on event.

7. The method of claim 1, wherein the initialization word is electronically readable.

8. The method of claim 1, wherein the initialization word is electronically writable.

9. The method of claim 1, wherein loading at least one initialization word from storage device includes determining if the storage device is present.

10. The method of claim 9, further comprising determining if a secondary external storage device is present if the external storage device is not present.

11. The method of claim 1, wherein the integrated circuit includes a processor and the at least one initialization word includes software executable on the processor.

12. A system comprising:
an integrated circuit including at least one initialization register;
a first storage device coupled to the at least one initialization register in the integrated circuit via a first bus; and
at least one initialization word stored in the first storage device, the initialization word being electronically readable, the at least one initialization word being capable of being read into the at least one initialization register upon an initialization event.

13. The system of claim 12, wherein the at least one initialization word is electronically writeable.

14. The system of claim 13, further comprising a system processor coupled to the first storage device, wherein the system processor is capable of writing the at least one initialization word into the first storage device.

15. The system of claim 12, wherein the at least one initialization word includes a checksum.

16. The system of claim 12, wherein the at least one initialization word includes a sequential access parameter.

17. The system of claim 12, wherein the at least one initialization word includes a random access parameter.

18. The system of claim 12, wherein the initialization event includes at least one of a reset event, a restart event or a power-on event.

19. The system of claim 12, further comprising a second storage device coupled to the at least one initialization register in the integrated circuit via the first bus.

20. An interface device comprising:
an interface circuit including at least one initialization register and an input/output processor;
a first storage device coupled to the at least one initialization register in the integrated circuit via a first bus;
at least one initialization word stored in the first storage device, the initialization word being electronically readable, the at least one initialization word being capable of being read into the at least one initialization register upon an initialization event;
a system processor coupled to the first storage device, the system processor being capable of writing the at least one initialization word into the first storage device, the system processor being coupled to the input/output processor by a system bus; and
a peripheral device coupled to the input/output processor by a peripheral device-specific bus.
